(19) United States
(12) Patent Application Publication
(10) Pub. No.: US 2010/0208286 A1
(43) Pub. Date: Aug. 19, 2010

(54) Image Processing Apparatus and Control Method of the Same

(75) Inventor: Akira IWATA, Shiojiri-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/687,015

(22) Filed: Jan. 13, 2010

(30) Foreign Application Priority Data
Feb. 19, 2009 (JP) 2009-036336

(51) Int. Cl. G06K 15/02

(52) U.S. Cl. 358/1.14

(57) ABSTRACT

An image processing apparatus for performing a predetermined job, includes: an operation panel; and a panel controller, wherein the panel controller detects whether a user operation received by the operation panel is a job starting operation or a reference/change operation and determines whether or not the user operation is an operation which is an object of user authentication, and the panel controller performs first authentication control of, when the job starting operation is received, requiring the user authentication and permitting starting of the job after authentication success, and performs second authentication control of, when a first reference/change operation is received when not in the authentication permission mode, requiring the user authentication, permitting the first reference/change operation after authentication success, and transferring to the authentication permission mode, and in the authentication permission mode, permitting the first reference/change operation and terminating the authentication permission mode in response to an termination operation.

### BACKGROUND

1. Technical Field

The present invention relates to an image processing apparatus such as a multi-function apparatus which performs an image reading process and an image data printing process, and more particularly, to an image processing apparatus having an user authentication function.

2. Related Art

A recent multi-function apparatus has a user authentication function in order to prevent information leakage due to unauthorized access. When the user authentication function is used, it is possible to prevent a case where a third party illegally takes a printing result and leaves or a case where a printing process, a mail delivery process, or the like is performed by an unauthorized user. For example, in a case where a user requests the multi-function apparatus to perform printing from a client PC connected to the multi-function apparatus through a network, the multi-function apparatus does not start the printing process immediately. After the user moves to a place where the multi-function apparatus is installed and performs a user authentication operation through an operation panel of the multi-function apparatus, when the authentication is successful, the multi-function apparatus starts the print out.

Such a multi-function apparatus requests user authentication at the time of starting an operation of the operation panel, and when the user is successful in authentication, the multi-function apparatus is transited to a log-in state and accepts operations of the user. When the operation is terminated, the log-in state needs to be terminated. The log-in state is terminated by the user pushing a log-out button on the operation panel or automatic log-out after a time set in advance by the multi-function apparatus elapses. However, there is a concern that information leakage will occur when the user forgets to push the log-out button or a third party commits an illegal act during the time before the automatic log-out.

Therefore, in JP-A-2007-228209, there is disclosed a technique of allowing a user to set a logout in advance at the time of starting an operation and automatically performing the logout at the time of terminating the operation.

In addition, JP-A-2008-263396 and JP-A-2008-263397 disclose a technique of setting an operation which takes a longer processing time than a predetermined time as a long job and automatically logging out at the time of terminating the operation in the case where the operation is a long job.

However, in JP-A-2007-228209, the panel has to display whether or not an automatic log-out is set and this must be determined by the user, so that there is a problem of inconvenience for the user.

In addition, in JP-A-2008-263396 and JP-A-2008-263397, when an operation is not a long job, the automatic logout is not performed, so that the problem of forgetting to logout remains.

### SUMMARY

An advantage of some aspects of the invention is that it provides an image processing apparatus capable of preventing log-out from being forgotten without inconveniencing a user.

According to an aspect of the invention, there is provided an image processing apparatus for performing a predetermined job and making a reference to or a change in the setting items of the predetermined job and the image processing apparatus, the image processing apparatus including: an operation panel that receives a job starting operation for instructing the execution of the job and a reference/change operation for making a reference to or a change in the setting items; and a panel controller that controls the operation panel, wherein the panel controller detects whether a user operation received by the operation panel is a job starting operation or a reference/change operation and determines whether or not the user operation is an operation which is an object of user authentication, and the panel controller performs first authentication control of, when a job starting operation that is an operation which is an object of user authentication is received, requiring the user authentication and permitting starting of the job after authentication success without transferring to an authentication permission mode, and performs second authentication control of, when a first reference/change operation that is an operation which is an object of user authentication is received when not in the authentication permission mode, requiring the user authentication, permitting the first reference/change operation after authentication success, and transferring to the authentication permission mode, and in the authentication permission mode, permitting the first reference/change operation without requiring the user authentication and terminating the authentication permission mode in response to an authentication permission mode termination operation.

In this aspect, user authentication is not required at the time of starting an operation using the operation panel of the image processing apparatus but user authentication is required when an operation that needs user authentication is performed from a plurality of selectable operations, so that the range of user authentication is not all the panel operations but is limited to particular operations. In a job starting operation which is an object of user authentication, after user authentication success, no transfer is made to an authentication permission mode, so that a logout operation is not necessary. Here, the logout operation is an operation of terminating the state where an operation which is an object of user authentication can be performed without user authentication. In addition, even in the image processing apparatus having a user authentication function, the user can perform, without authentication, operations which are not objects of user authentication. The first reference/change operation transfers to the authentication permission mode after user authentication success, user authentication is not required during the authentication permission mode, and the authentication permission mode is automatically terminated in response to the authentication permission mode termination operation. Accordingly, it is possible to eliminate the complexity that results from maintaining the authentication permission mode in a predetermined range and repeating the user authentication in the first reference/change operation.

According to the above aspect of the invention, the first reference/change operation is an operation in a setting menu having a setting screen with a plurality of the setting items, and the authentication permission mode termination operation is a termination operation of the setting menu.

In this aspect, in the setting menu having the setting screen with a plurality of the setting items, when reference/change operations to a plurality of the setting items are continuously performed, during the authentication permission mode even for an operation which is an object of user authentication and the first reference/change operation can be performed. In addition, at the time of terminating the setting menu, the authentication permission mode is automatically terminated, so that an additional logout operation is not necessary. Accordingly, a logout operation can be prevented from being forgotten without inconveniencing the user.

According to the above aspect of the invention, the panel controller performs third authentication control of, when the user operation is a second reference/change operation which is an object of the user authentication, requiring the user authentication, and permitting the second reference/change operation after authentication success without transferring to the authentication permission mode.

In this aspect, the second reference/change operation does not cause a transfer to the authentication permission mode after user authentication, so that a logout operation is not necessary.

According to the above aspect of the invention, in the third authentication control, when the user operation is the second reference/change operation which is the object of the user authentication and is a change operation relating to the same setting item continuously performed for a predetermined period after the user authentication for the reference operation that is the second reference/change operation which is the object of the user authentication was successful, the change operation is permitted without requiring the user authentication.

In this aspect, when the preceding user operation is a reference operation of the second reference/change operation which is an object of user authentication and user authentication was successful, in a case where a change operation relating to the same setting item is subsequently performed within a predetermined period, user authentication is not required at the time of performing the change operation.

According to the above aspect of the invention, the job starting operation or the first or second reference/change operation which are objects of user authentication may be selected by a manager.

In this aspect, since the manager can select operations that need user authentication and therefore can select objects of user authentication in accordance with their purposes, thereby enhancing convenience for the user.

According to the above aspect of the invention, in the second authentication control, the authentication permission mode is terminated when the operation panel is not operated for a predetermined period during the authentication permission mode.

In this aspect, when an operation is not performed for a predetermined interval, the authentication permission mode is terminated, so that it is possible to prevent illegal use by a third party.

According to the above aspect of the invention, the image processing apparatus includes at least an image reading unit and an image printing unit, and the predetermined job includes an image reading process and an image data printing process.

According to the above aspect of the invention, the image processing apparatus includes at least an image reading unit and an image printing unit, and the setting items include communication related items of the image processing apparatus. The setting items of the image processing apparatus include communication related items such as items concerning whether or not to perform communication setting of the image processing apparatus, as well as IP address items.

According to another aspect of the invention, there is provided a control method of an image processing apparatus for performing a predetermined job and making a reference to or a change in the setting items of the predetermined job and the image processing apparatus, the control method including: a panel control process of receiving a job starting operation for instructing the execution of the job and a reference/change operation for making a reference to or a change in the setting items by an operation panel, wherein the panel control process includes: an operation determination process of detecting whether a user operation received by the operation panel is a job starting operation or a reference/change operation and determining whether or not the user operation is an operation which is an object of user authentication; a first authentication control process of, when a job starting operation that is an operation which is an object of user authentication is received as the user operation, requiring the user authentication, and permitting starting of the job after authentication success, without transferring to an authentication permission mode; and a second authentication control process of, when a first reference/change operation that is an operation which is an object of user authentication is received as the user operation when not in the authentication permission mode, requiring the user authentication, permitting the first reference/change operation after authentication success, and transferring to the authentication permission mode, and in the authentication permission mode, permitting the first reference/change operation without requiring the user authentication, and terminating the authentication permission mode in response to an authentication permission mode termination operation.

### BRIEF DESCRIPTION OF THE DRAWINGS

The invention will be described with reference to the accompanying drawings, wherein like numbers reference like elements.

FIG. 1 is a diagram illustrating the internal configuration of an image processing apparatus according to an embodiment.

FIG. 2 is a diagram illustrating an operation panel.

FIG. 3 is a flowchart of a process performed when a user operation is performed.

FIG. 4 is a flowchart of a process performed when a second reference/change operation is performed.

FIGS. 5A to 5F are diagrams of a panel transition shown when a print starting operation that is a job starting operation is performed.

FIGS. 6A to 6D are diagrams of a panel transition shown when a reference/change operation other than an object of user authentication is performed.

FIGS. 7A to 7F are diagrams of a panel transition shown when a first reference/change operation is performed.

FIGS. 8A to 8F are diagrams of a panel transition shown when a first reference/change operation is performed in an authentication permission mode.

FIGS. 9A to 9D are diagrams of a panel transition shown when a reference/change operation other than an object of user authentication is performed.

FIGS. 10A to 10F are diagrams of a panel transition shown when a second reference/change operation is performed.

FIGS. 11A to 11E are diagrams of a panel transition shown when a series of second reference/change operations is performed.

### DESCRIPTION OF EXEMPLARY EMBODIMENTS

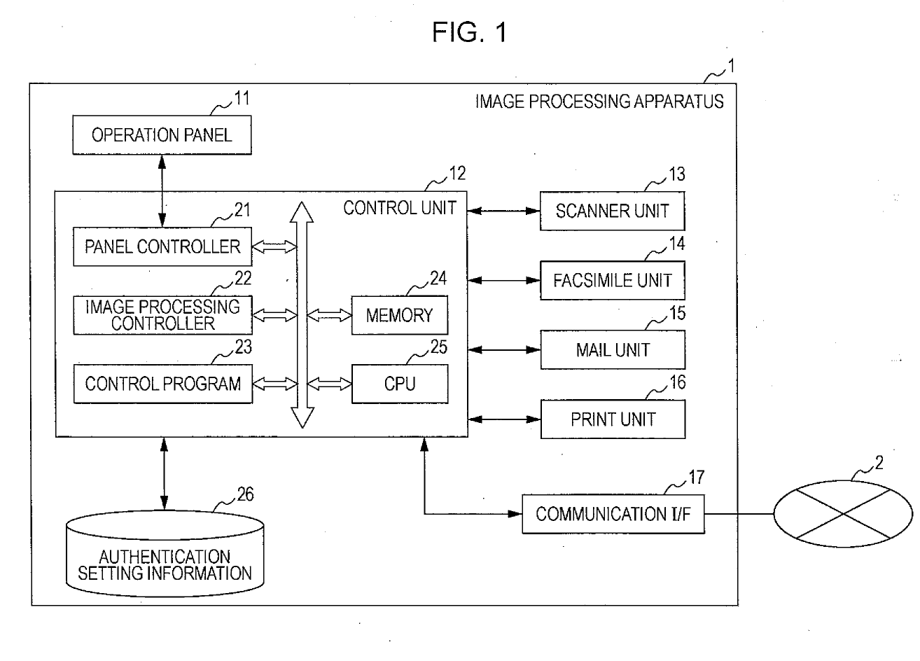

Hereinafter, a first embodiment of the invention will be described in detail with reference to the accompanying drawings. FIG. 1 is a block diagram illustrating the configuration of an image processing apparatus 1 according to the embodiment. In FIG. 1, the image processing apparatus 1 includes an operation panel 11, a control unit 12, authentication setting information 26 for a user authentication function, a scanner unit 13, a facsimile unit 14, a mail unit 15, a print unit 16, and a communication interface 17. The image processing apparatus 1 is connected to a LAN 2 through the communication interface 17 and can be connected to a client PC or the like via the LAN 2.

The control unit 12 includes a panel controller 21 for controlling the operation panel 11, an image processing controller 22, a control program 23, a memory 24, and a CPU 25. The control unit 12 controls the entire image processing apparatus 1 by executing the control program 23 and implements functions such as scanning, faxing, mailing, printing, and the like by cooperating with the scanner unit 13, the facsimile unit 14, the mail unit 15, and the print unit 16 included in the image processing apparatus 1.

The image processing controller 22 reads a document using a platen (not shown) set in the image processing apparatus 1 to generate image data that is digital data. The control unit 12 prints the generated image data on a paper medium or transmits the data to another digital multi-function apparatus by cooperating with each unit.

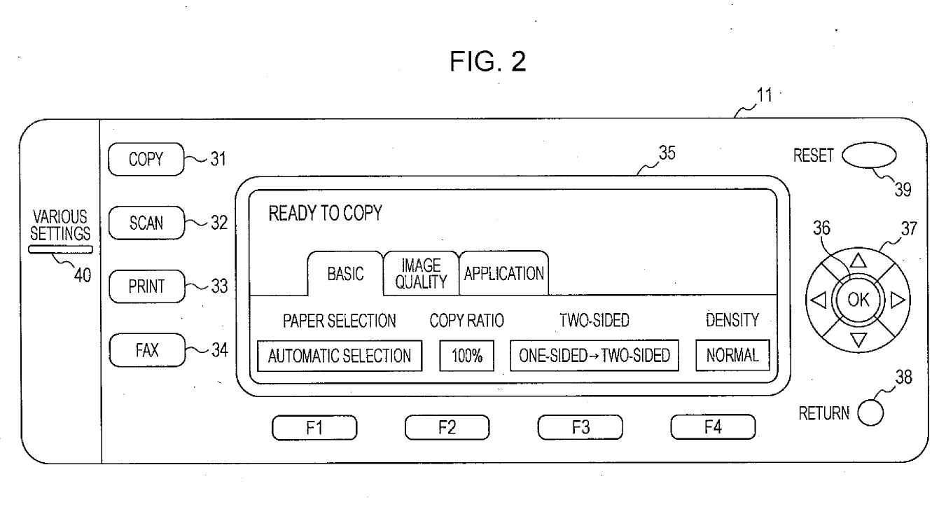

The panel controller 21 displays a menu screen or the like on a panel display screen (35 in FIG. 2) of the operation panel 11 and identifies input information from the operation panel 11 to detect operation content from a user. In addition, the panel controller 21 switches between contents to be displayed in the panel display screen 35 of the operation panel 11 according to the operation content from the user.

FIG. 2 is a diagram illustrating the operation panel 11 of the image processing apparatus 1. The operation panel 11 includes the panel display screen 35 and a plurality of operation buttons. The panel display screen 35 is a liquid crystal panel for displaying the current status of the image processing apparatus 1 or the menu screen using texts and figures. The operation buttons include function menu display buttons 31, 32, 33, and 34, a various settings menu button 40, an OK button 36, a directional key 37, a return button 38, and a reset button 39. The user pushes the operation buttons while looking at the panel display screen 35 to input commands corresponding to the operation of the image processing apparatus 1.

The function menu display buttons 31 to 34 are buttons for displaying operation menus for the functions of the image processing apparatus 1 on the panel display screen 35. When one of the copy button 31, the scan button 32, the print button 33, and the fax button 34, which are the function menu display buttons, is pushed, the panel controller 21 displays the function menu on the panel display screen 35. In addition, when the various settings button 40 is pushed, the panel controller 21 displays a various setting menu on the panel display screen 35. In the various setting menu, an operation of making a reference to/change in a setting item related to the image processing apparatus 1 is performed.

The OK button 36 is used to start an operation of the copy, scan, print, and fax functions, select a setting item, or confirm the selection of a value of the setting item. The directional key 37 is used to change the selection of the setting item or change the selection of a value of the setting item. The return button 38 is used to return to a previous screen that was displayed on the panel display screen or terminate the various setting menu. The reset button 39 is used to return the changed value of the setting item to an initial value when a function menu such as the copy function menu is used.

The authentication setting information 26 in FIG. 1 stores at least user operation information which is an object of user authentication and collation information for authentication. The information may be input from the operation panel 11 of the image processing apparatus 1 or input from the client PC connected to a network through a driver application or the like for setting the authentication setting information 26.

As a method of user authentication, the user may input passwords using a number pad (not shown) as authentication information or input authentication information using an IC card or using biometric authentication. The control unit 12 detects whether or not the received user operation is an object operation of user authentication with reference to the authentication setting information 26. When the user operation is an object operation of user authentication, the control unit 12 displays a user authentication screen on the panel display screen 35. When the user inputs authentication information, the control unit 12 determines whether or not the received authentication information matches with the collation information of the authentication setting information 26.

The image processing apparatus 1 as described above is a multi-function apparatus having a copy function, a scan function, a print function, and a facsimile function. The image processing apparatus 1 performs a printing process of outputting image data onto a paper medium through a network printer in response to a print request from the client PC connected through the communication interface 17 and the LAN 2, a storage process of image data read by the scanner function to the client PC, a transmission/reception process of the data to/from a mail server, and the like. In addition, the image processing apparatus 1 includes a modem (not shown) for performing a flow of facsimile transmission and performs image data transmission/reception using a public telephone line (not shown).

Operations of the image processing apparatus 1 in this embodiment include processes such as copying, scanning, printing, and fax transmission/reception. In addition, the setting items include setting items of the jobs and setting items of the image processing apparatus 1. For example, the setting items of the jobs include “paper selection”, “copy ratio”, “two-sided”, “density”, and the like as setting items for copy, and the setting items of the image processing apparatus 1 include “system information”, “display language”, “common setting”, and the like. In the authentication setting information 26, job starting operations and first and second reference/change operations which are objects of user authentication are determined in advance.

The user operations are operations that the user performs on the operation panel 11 and are classified into job starting operations, reference/change operations, and other operations.

The job starting operations are operations which start jobs such as copying, scanning, printing, and faxing. The user performs the job starting operation by pushing the OK button 36 in a state where a function menu of a job which is an object of execution is displayed on the panel display screen 35.

The reference/change operations are operations of making a reference to/change in the setting items of the job and the image processing apparatus 1 and are classified into first reference/change operations and second reference/change operations. In this embodiment, a reference/change operation of setting items of various setting menus that are setting menus including a plurality of setting items of the image processing apparatus 1 is referred to as the first reference/change operation. A reference/change operation of setting items of a function menu screen of each job is referred to as the second reference/change operation.

The first reference/change operation includes a reference operation and a change operation. The user performs a reference operation of “display language” by selecting, for example, a “display language” item of the various settings menu and pushing the OK button 36. In addition, the user performs a change operation of “display language” by selecting a language from options and pushing the OK button 36 in a state where the “display language” screen is displayed.

Similarly, the second reference/change operation' includes a reference operation and a change operation. The user performs a reference operation of “paper selection” by selecting, for example, a “display language” item as a setting item of a job in a copy function menu and pushing the OK button 36. In addition, the user performs a change operation of “display language” by selecting a paper from options and pushing the OK button 36 in a state where the “paper selection” screen is displayed.

In this embodiment, an authentication permission mode termination operation is, for example, an operation of pushing the return button 38 in a state where a various settings menu is displayed on the panel display screen 35.

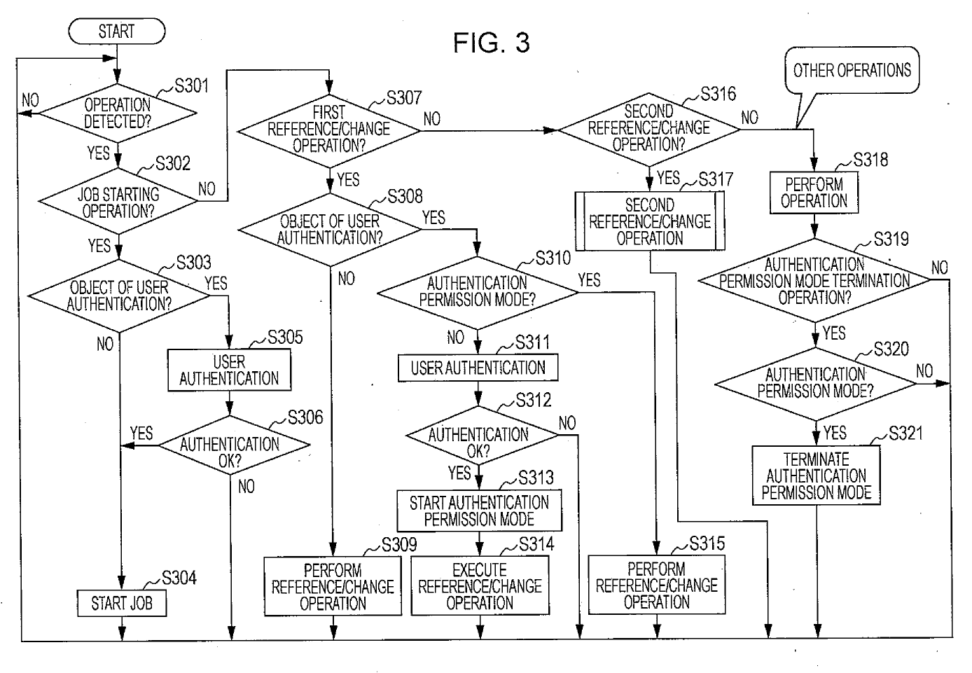

FIG. 3 is a flowchart of a process performed when the operation panel 11 is operated by the user. A summary of operation panel control will be described with reference to the flowchart.

When the image processing apparatus 1 is switched on, the image processing apparatus 1 is in a user operation reception standby state (Step S301). When the control unit 12 detects a user operation, it determines whether or not the user operation is a job starting operation (Step S302).

When the detected user operation is a job starting operation (Yes in Step S302), the control unit 12 determines whether or not the user operation is an object operation of user authentication (Step S303). When the user operation is not an object operation of user authentication, the control unit 12 starts the operation without displaying a user authentication screen on the panel display screen 35 (Step S304).

When the detected user operation is an object operation of user authentication which is a job starting operation (Yes in Step S303), the control unit 12 displays the user authentication screen that requires user authentication on the panel display screen 35 (Step S305). When the user authentication by the user is successful (Yes in Step S306), the control unit 12 starts the operation. When the user fails the user authentication (No in Step S306), the control unit 12 does not start the operation but returns to the user operation reception standby state (Step S301). With regard to the user authentication for the job starting operation, only the user starting operation is authenticated, so that the authentication permission mode is not allowed even when the authentication is successful.

When the detected user operation is the first reference/change operation (Yes in Step S307), the control unit 12 determines whether or not the user operation is the object operation of user authentication (Step S308). When the detected user operation is not the object operation of user authentication (No in Step S308), the control unit 12 performs the reference/change operation without displaying the user authentication screen (Step S309).

When the detected user operation is the object operation of user authentication (Yes in Step S308) as the first reference/change operation (Yes in Step S307), the control unit 12 checks whether or not currently in the authentication permission mode (Step S310). When it is not in the authentication permission mode (No in Step S310), the control unit 12 displays the user authentication screen on the panel display screen 35 (Step S311). When the user is successful in user authentication (Yes in Step S312), the control unit 12 starts the authentication permission mode (step S313) and performs the reference/change operation (Step S314). When the user fails the user authentication (No in Step S312), the control unit 12 returns to the user operation reception standby state without performing the reference/change operation (Step S301).

In addition, when the detected user operation is an object operation of user authentication (Yes in Step S308) which is the first reference/change operation (Yes in Step S307) and it is in the authentication permission mode (Yes in Step S310), the control unit 12 performs the reference/change operation without displaying the user authentication screen (Step S315) even though the user operation is an object operation of user authentication.

The case where the detected user operation is the second reference/change operation (Yes in Step S316) will be described in a second embodiment.

In addition, when the detected user operation is neither a job starting operation nor the first or second reference/change operation but is another operation, the control unit 12 performs the operation (Step S318). In addition, the control unit 12 determines whether or not the user operation is an authentication permission mode termination operation (step S319). When the user operation is an authentication permission mode termination operation, the control unit 12 checks whether or not it is in the authentication permission mode (Step S320). When it is in the authentication permission mode (Yes in Step S320), the control unit 12 terminates the authentication permission mode (Step S321). When the user operation is not an authentication permission mode termination operation (No in Step S319) and it is not in the authentication permission mode (No in Step S320), the control unit 12 returns to the user operation reception standby state (Step S301).

### EXAMPLES

Hereinafter, Examples of first authentication control for a job starting operation which is an object of user authentication and second authentication control for a first reference/change operation which is an object of user authentication will be described.

For an example of a job starting operation which is an object of user authentication, the user requests the image processing apparatus 1 to perform printing from the client PC, and the user operates the image processing apparatus 1 to start the printing. Then, for an example of the first reference/change operation, an operation of making a reference to/change in the setting item of the image processing apparatus 1 by pushing the various settings button 40 is performed. This will be described with reference to the panel display screen 35.

In this embodiment, job starting operations and reference/change operations requiring user authentication are set in advance. In this embodiment, a print starting operation that is a job starting operation, and a reference/change operation of “display language” and “common setting” items that are setting items in the various settings menu are set as operations which are objects of user authentication. In addition, a reference/change operation of “user data” in a print function menu and a reference operation of “system information” which is a setting item in the various settings menu are operations which are not objects of user authentication.

In addition, since the reference/change operation of “user data” in the print function menu is a second reference/change operation but is not an operation which is an object of user authentication, it does not correspond to third authentication control. The third authentication control on the second reference/change operation which is an object of user authentication will be described according to a second example.

When the user requests the image processing apparatus 1 to print image data from the client PC connected through the network, the image processing apparatus 1 receives the print request from the client PC. Then, the user moves to a place where the image processing apparatus 1 is located and performs the following operations on the operation panel 11 of the image processing apparatus 1.

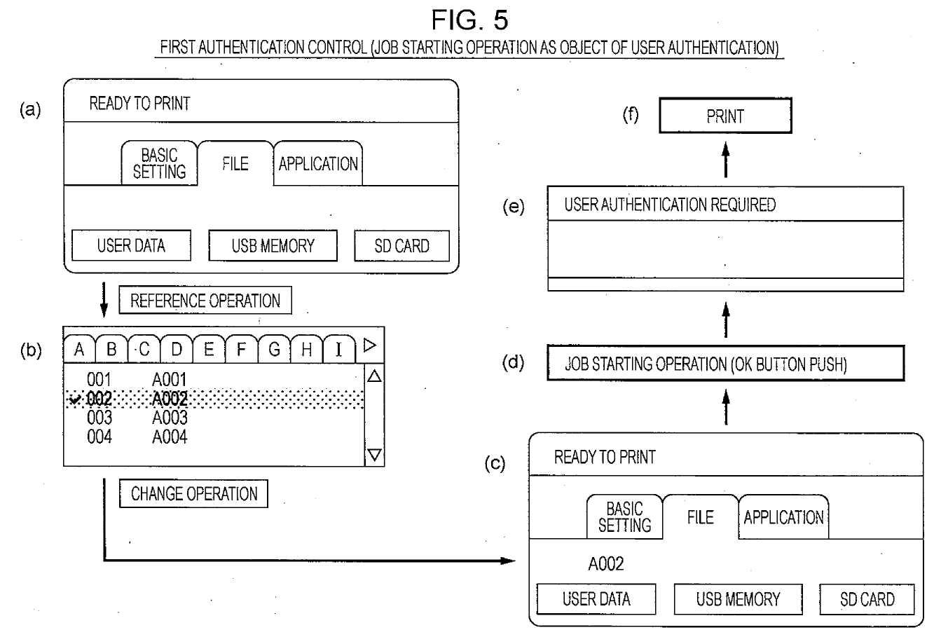

FIGS. 5A to 5F are diagrams of a panel transition shown when a print starting operation that is the job starting operation which is an object of user authentication is performed. First, the user pushes the print button 33 of the operation panel 11. When the print button 33 is pushed, the control unit 12 displays the print function menu on the panel display screen 35. FIG. 5A is a diagram illustrating the print function menu. In the print function menu, when a “file tap” is selected by pushing the directional key 37 and the OK button 36 and then a “user data” tap is selected to show a user data list as printing objects, the control unit 12 performs a reference operation of the “user data” and displays a “user data” screen as illustrated in FIG. 5B on the panel display screen 35. As described above, since the reference operation of the “user data” is not an object operation of user authentication, the control unit 12 does not display the user authentication screen.

When “A002” which is an printing object is selected by using the directional key 37 from the options on the “user data” screen and the OK button 36 is pushed, since the change operation of “user data” is not an operation which is an object of user authentication, the control unit 12 performs the change operation of “user data” without displaying the user authentication screen. After the change operation, the control unit 12 displays the print function menu on the panel display screen 35 as illustrated in FIG. 5C and displays the “A002” on a part corresponding to user data.

In the state where the print function menu is displayed, when the user pushes the OK button 36 (FIG. 5D), this becomes a job starting operation, and a printing starting operation that is a kind of job is performed. The printing starting operation is an operation which is an object of user authentication, so that the control unit 12 displays the user authentication screen as illustrated in FIG. 5E. In addition, the starting of a job may not be performed by pushing the OK button 36 but the starting of a job may be performed by pushing a start button (not shown) provided separately from the OK button 36.

In this embodiment, a user authentication operation is performed by the user inputting passwords using a number pad (not shown). When the user inputs passwords and pushes the OK button 36, the control unit 12 determines whether or not authentication information matches with the authentication information with reference to the collation information of the authentication setting information 26. When the authentication information matches with the authentication information and the user authentication is successful, the control unit 12 performs printing of the user data “A002” (FIG. 5F).

As described above, user authentication is not required at the time of starting an operation using the operation panel 11 of the image processing apparatus 1 but user authentication is required when a job starting operation such as a print starting operation that needs user authentication is performed from a plurality of selectable operations, so that the range of user authentication is not all the panel operations but is limited to particular operations. In addition, after successful user authentication, no transfer is made to an authentication permission mode, so that a logout operation that represents a termination operation of the authentication permission mode is not necessary. That is, objects of user authentication are limited only to job starting operations. Accordingly, a logout operation can be prevented from being forgotten without inconveniencing the user.

Next, second authentication control on a first reference/change operation which is an object of user authentication will be described.

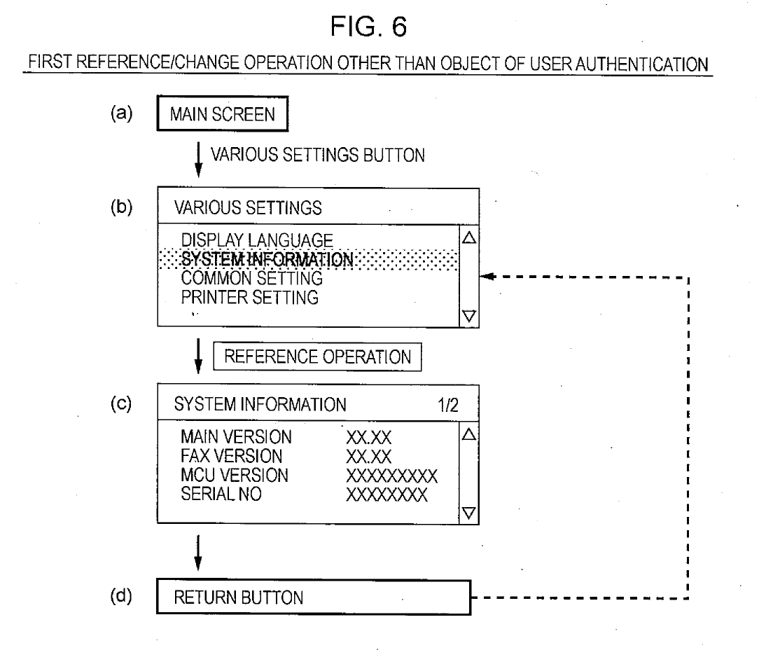

FIGS. 6A to 6D are diagrams of a panel transition shown when a first reference/change operation which is not an object of user authentication is performed. Next, when the user pushes the various settings button 40, the control unit 12 displays the “various settings menu” as illustrated in FIG. 6B on the panel display screen 35. When the user selects “system information” from the various settings menu, since a reference operation of the “system information” is an operation which is not an object of user authentication, the control unit 12 displays a reference screen as illustrated in FIG. 6C without displaying the user authentication screen.

When the user pushes the return button 38 on the “system information” screen (FIG. 6D), the control unit 12 displays the “various settings menu” (FIG. 6B). Pushing the return button 38 corresponds to operations (No in Step S316 of FIG. 3) other than job starting operations and the first and second reference/change operations, and the return button 38 on the “system information” screen does not correspond to the permission mode termination operation, so that the control unit 12 does not perform the permission mode termination operation.

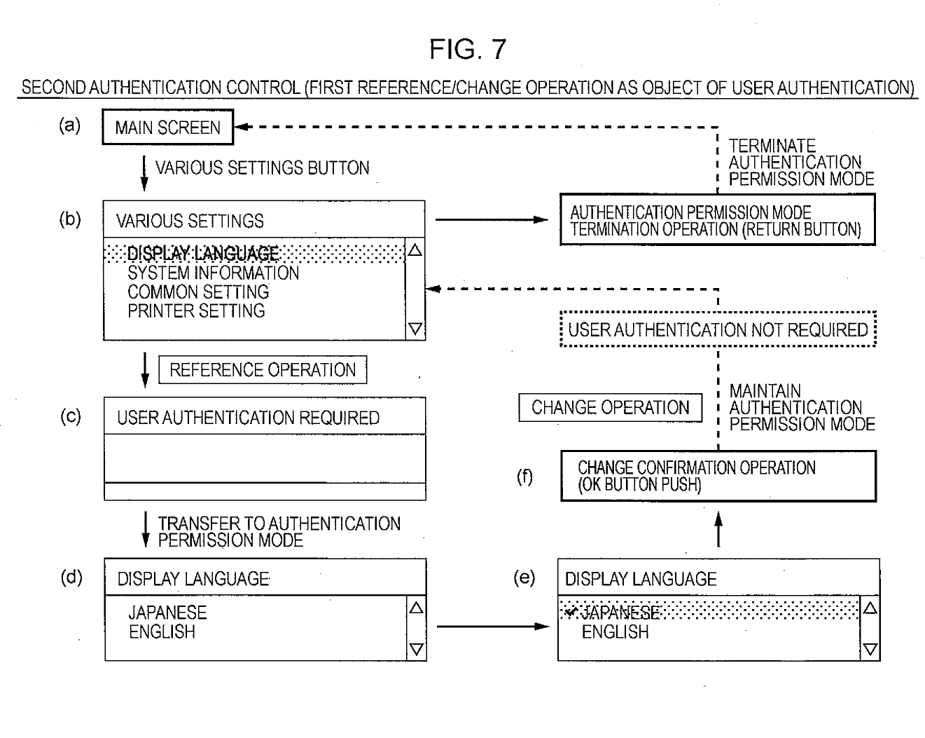

Next, FIGS. 7A to 7F are diagrams of a panel transition shown when a first reference/change operation which is an object of user authentication is performed. When the user selects “display language” on the various settings menu and pushes the OK button 36, since a reference operation of “display language” is an operation which is an object of user authentication, the control unit 12 displays the user authentication screen as illustrated in FIG. 7C. When the user inputs suitable passwords and pushes the OK button 36 and authentication is successful, as illustrated in FIG. 7D, the control unit 12 displays the “display language” screen referring to the display language. As the user authentication is successful, the control unit 12 starts the authentication permission mode.

In addition, when the user selects “Japanese” on the “display language” screen (FIG. 7E) and pushes the OK button 36 to perform a change operation (FIG. 7F), the control unit 12 performs the change operation of the “display language” item. Similar to the reference operation, the change operation of the “display language” is an operation which is an object of user authentication. However, since it is in the authentication permission mode, the control unit 12 performs the change operation of “display language” without displaying the user authentication screen. Here, the control unit 12 maintains the authentication permission mode. When the change operation is completed, the control unit 12 displays a various settings menu on the panel display screen 35 (FIG. 7B).

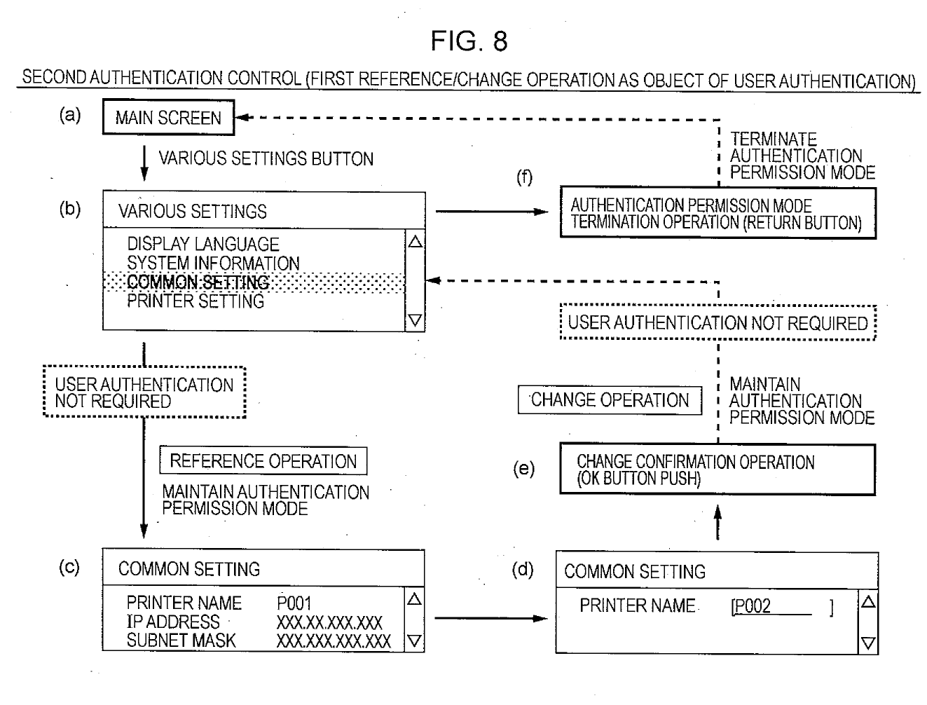

FIGS. 8A to 8F are diagrams of a panel transition shown when a first reference/change operation which is an object of user authentication is performed in the authentication permission mode. Continuing from the operations in FIGS. 7A to 7E, when the user selects the “common setting” from the various settings menu (FIG. 8B), although a reference operation of the “common setting” is an operation which is an object of user authentication, since it is in the authentication permission mode due to the user authentication of FIGS. 7A to 7E, the control unit 12 displays the “common setting” screen as illustrated in FIG. 8C without displaying the user authentication screen. Here, the control unit 12 maintains the authentication permission mode.

In addition, as illustrated in 8D, “printer name” is changed in the “common setting” screen. When the change operation is performed by changing the “printer name” and pushing the OK button 36 (FIG. 8E), the control unit 12 performs the change operation of the “printer name” item. Although the change operation of the “printer name” is an operation which is an object of user authentication, since it is in the authentication permission mode, the control unit 12 performs the change operation of the “printer name” without displaying the user authentication screen. Here, the control unit 12 maintains the authentication permission mode. When the change operation is completed, the control unit 12 displays a various settings menu on the panel display screen 35 (FIG. 8B).

In addition, with reference to the “printer name”, in the case where it does not need to be changed, when the return button 38 is pushed while the “common setting” screen is displayed, the control unit 12 displays the various settings menu again (FIG. 8B). Pushing the return button 38 corresponds to the other operations (No in Step S316 of FIG. 3), however, the return button 38 on the “common setting” screen is not a permission mode termination operation, so the control unit 12 maintains the authentication permission mode.

In addition, next, when the return button 38 is pushed while the various settings menu of FIG. 8B is displayed (FIG. 8F), since the return button 38 in the various settings menu screen corresponds to the permission mode termination operation corresponding to the termination operation of the various settings menu, the control unit 12 terminates the authentication permission mode and displays the main screen (FIG. 8A). That is, the authentication permission mode is automatically terminated corresponding to the termination operation of the setting menu.

When the various settings button is re-pushed, the control unit 12 displays the various settings menu. When the user re-selects the “common setting” item, since it is not in the authentication permission mode, the control unit 12 displays the user authentication screen at this time. When the user inputs suitable passwords and pushes the OK button 36, authentication is successful, and the control unit 12 starts the authentication permission mode and displays the “common setting” screen. In the case where the return button 38 is pushed while the various settings menu of FIG. 7B is displayed, similarly, the authentication permission mode is terminated.

As described above, user authentication is not required at the time of starting an operation using the operation panel 11 of the image processing apparatus 1, but user authentication is required when an operation such as a reference operation of the “display language” that needs user authentication is performed from a plurality of selectable operations, so that the range of user authentication is not all the panel operations but is limited to particular operations.

In addition, after user authentication success, transfer is made to the authentication permission mode, and user authentication is not required to perform a reference/change operation during the authentication permission mode. Accordingly, in this embodiment, the second authentication control is particularly effective for the setting menu including a large number of setting items of objects of user authentication, such as the various settings menu. In addition, the authentication permission mode is automatically terminated in response to a termination operation of the authentication permission mode such as the termination operation of the various settings menu, so that an additional logout operation is not necessary. Therefore, a logout can be prevented from being forgotten without inconveniencing the user.

### First Modified Example of First Embodiment

In the first embodiment described above, the print start operation or the reference operations and the change operations of the “display language” and the “common setting” of the various settings item menu are operations which are objects of user authentication, however, job starting operations or setting/reference operations which are objects of user authentication may be arbitrarily selected by a manager.

For example, the print starting operation that is a job starting operation may be set to be an object of user authentication, and the scan starting operation may be set to an operation other than an object of user authentication. In addition, the reference/change operation of the “display language” may be set to be an operation which is not an object of user authentication, and the reference/change operation of the “common setting” may be set to an operation which is an object of user authentication.

Accordingly, the manager can select operations that need user authentication and therefore can select objects of user authentication in accordance with their purposes. Therefore, it is possible to optimize the security level, thereby enhancing convenience for the user.

In addition, among reference/change operations, both the reference operation and the change operation of a setting item may be set to operations which are objects of user authentication. Otherwise, the reference operation of the corresponding item may be set to an operation which is not an object of user authentication and only the change operation of the corresponding item may be set to an operation which is an object of user authentication.

Accordingly, the setting contents or options of the setting item may be freely referred to without authentication, and the change operation of the corresponding item may be set to require user authentication.

### Second Modified Example of First Embodiment

In the embodiment described above, the authentication permission mode was terminated by terminating the various settings menu on the panel display screen. Accordingly, the user does not need to perform an additional logout operation. However, the authentication permission mode may be set to be terminated when the operation panel 11 is not operated for a predetermined period during the authentication permission mode.

For example, when the operation panel 11 is not operated for 3 minutes from the last operation during the authentication permission mode, the control unit 12 terminates the authentication permission mode and displays the main screen on the panel display screen 35. Accordingly, even when the authentication permission mode termination operation is forgotten after starting the authentication permission mode, illegal operation by a third party can be prevented.

### Second Embodiment

Third authentication control of performing a second reference/change operation which is an object of user authentication according to a second embodiment will be described.

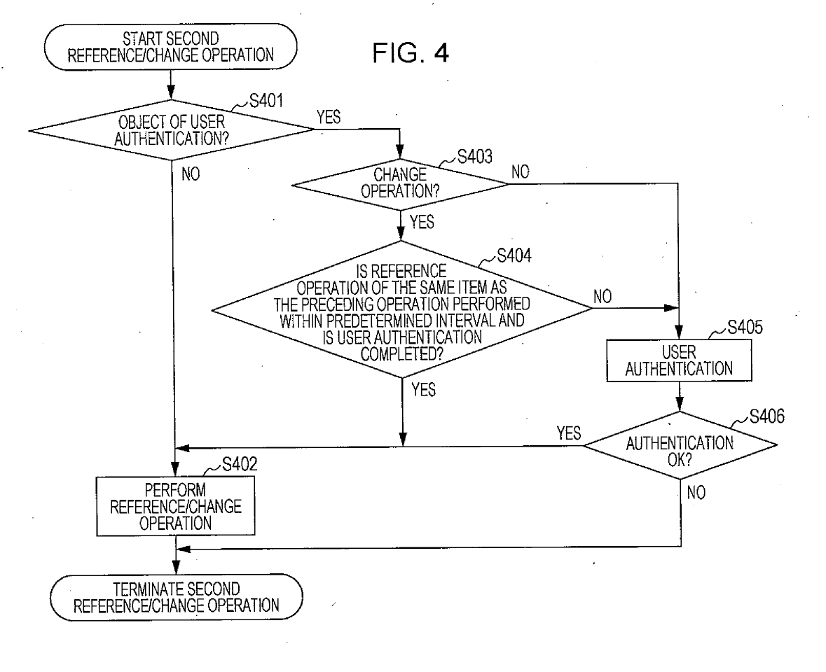

FIG. 4 is a flowchart of a process of the third authentication control performed when a detected user operation is the second reference/change operation which is an object of user authentication. The flow of the process until the operation content is determined after the control unit 12 detects the user operation is the same as that of the first embodiment illustrated in FIG. 3.

When the detected user operation is the second reference/change operation (Step S317 of FIG. 3), the control unit 12 determines whether or not the second reference/change operation is an operation which is an object of user authentication (Step S401). When the user operation is not an operation which is an object of user authentication (No in Step S401), the control unit 12 performs the reference/change operation (Step S402). When the user operation is an operation which is an object of user authentication (Yes in Step S401), the control unit 12 determines whether or not the user operation is a change operation (Step S403).

When the user operation is the change operation (Yes in Step S403), the control unit 12 determines whether or not the preceding operation is a reference operation which is an object of user authentication relating to the same setting item performed within a predetermined interval and user authentication was successful (Step S404). When the preceding operation is a reference operation which is an object of user authentication relating to the same setting item performed within the predetermined interval and user authentication was successful (Yes in Step S404) and the corresponding user operation is the change operation of the reference/change operation relating to the same setting item, since the user authentication was completed in the reference operation, the control unit 12 performs the change operation without displaying the user authentication screen (Step S402).

When the user operation is not a change operation but a reference operation (No in Step S403), or when the conditions that the preceding operation is the reference operation which is an object of user authentication relating to the same setting item performed within a predetermined interval and user authentication was successful are not satisfied (No in Step S404), the control unit 12 displays the user authentication screen (Step S405). When user authentication is successful (Yes in Step S406), the control unit 12 performs the corresponding reference/change operation (Step S402). When the user authentication fails (No in Step S406), the control unit 12 returns to the user operation reception standby state without performing the reference/change operation (Step S301 of FIG. 3).

As described above, in the second reference/change operation, the maintenance of the authentication permission mode is limited to a pair of operations which have a close relationship, that is, which are a reference operation and a change operation relating to the same setting item.

### Examples

Examples of the third authentication control of performing the second reference/change operation which is an object of user authentication will be described. An example of a process of performing scanning that is a job starting operation after performing settings of “resolution” and “storage” that are setting items of the scan function menu as the second reference/change operation will be described with reference to the panel display screen 35.

In this embodiment, a reference operation and a change operation of the “storage” which is a setting item of the scan function menu and a scan starting operation that is a job starting operation are set to be operations which are objects of user authentication. In addition, a second reference/change operation which is an object of user authentication may be arbitrarily selected by the manager. Accordingly, since the manager can select operations that need user authentication, the manager can select objects of user authentication in accordance with their purposes. Therefore, it is possible to optimize the security level, thereby enhancing convenience for the user.

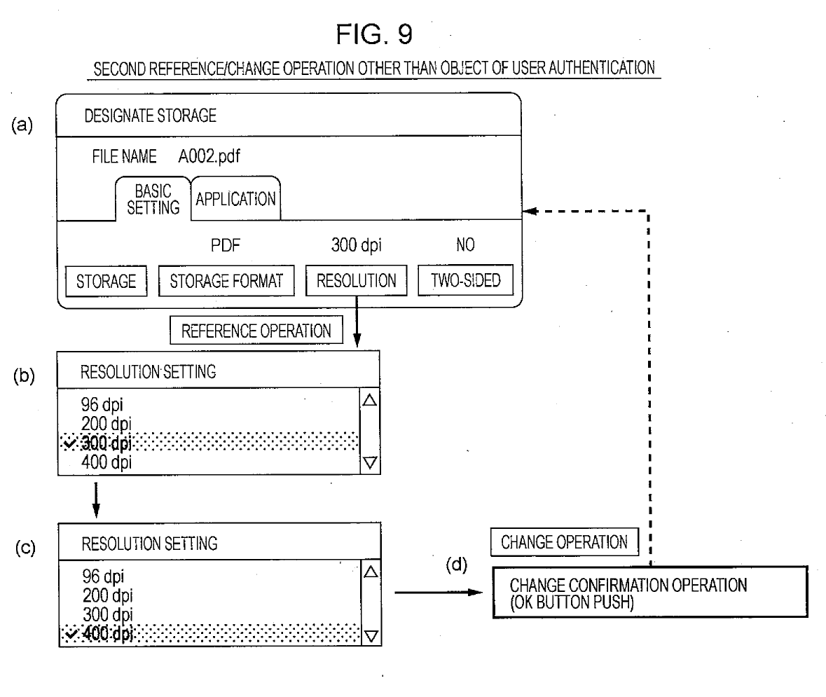

FIGS. 9A to 9D are diagrams of a panel transition shown when a reference/change operation which is not an object of user authentication is performed. When the user pushes the scan button 32 of the operation panel 11, the control unit 12 displays a scan function menu as illustrated in FIG. 9A on the panel display screen 35. When the user selects and refers to the “resolution” using the directional key 37 and the OK button 36 from the scan function menu, since the reference operation of the “resolution” is not an operation which is an object of user authentication, the control unit 12 displays a “resolution” screen as illustrated in FIG. 9B without displaying the user authentication screen.

When the user selects “400 dpi” using the directional key 37 from options on the “resolution” screen (FIG. 9C) and pushes the OK button 36 (FIG. 9D), since the change operation of the “resolution” is not an operation which is an object of user authentication, the control unit 12 changes the value of the “resolution” from 300 dpi to 400 dpi without displaying the user authentication screen.

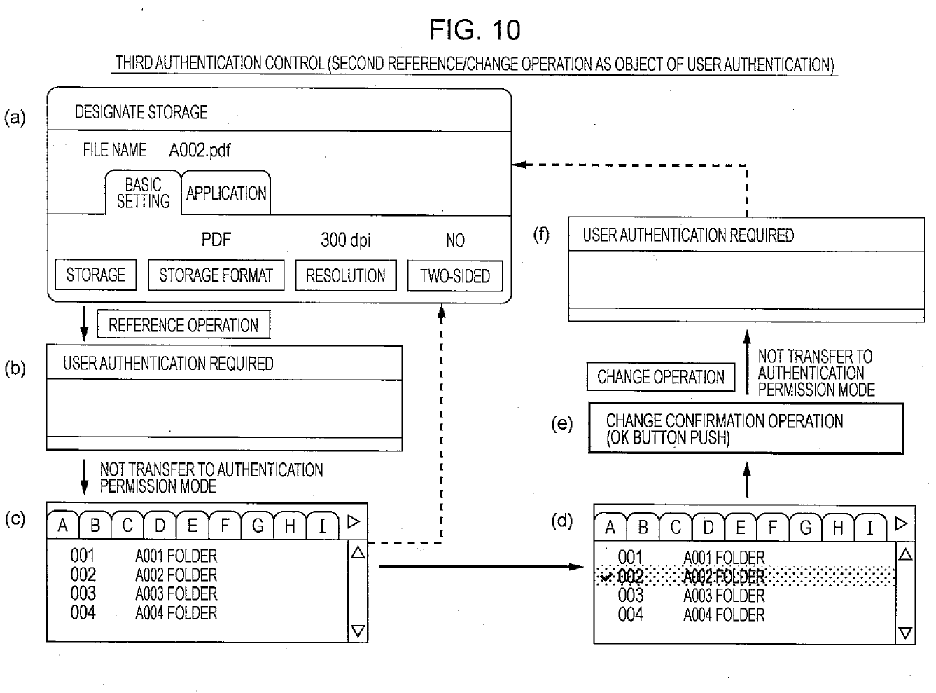

FIGS. 10A to 10F are diagrams of a panel transition shown when a second reference/change operation which is an object of user authentication is performed. When the user is to select and refer to the “storage” by pushing the OK button 36 from the scan function menu (FIG. 10A), since the reference operation of the “storage” item is an operation which is an object of user authentication, the control unit 12 displays the user authentication screen as illustrated in FIG. 10B. When the user is successful in authentication by inputting suitable passwords and pushing the OK button 36, the control unit 12 displays the “storage” screen as illustrated in FIG. 10C. Unlike the second authentication control for the first reference/change operation, in the third authentication control for the second reference/change operation, the control unit 12 does not start the authentication permission mode.

In addition, when the user is to select “002 A002 folder” (FIG. 10D) on the “storage” screen and change the “storage” by pushing the OK button 36 (FIG. 10E), since the change operation of the “storage” item is not an operation which is an object of user authentication, the control unit 12 displays the user authentication screen as illustrated in FIG. 10F. When the user is successful in authentication by inputting suitable passwords and pushing the OK button 36, the control unit 12 changes the “storage” item to the “002 A002 folder”. As in the reference operation of the “storage” item, the control unit 12 does not start or maintain the authentication permission mode.

As described above, in the third authentication control of performing the second reference/change operation which is an object of user authentication, even when user authentication is required for every operation and the user authentication is successful, no transfer is made to the authentication permission mode. Accordingly, the user does not need to perform a logout operation. While the second authentication control is effective in the case where reference/change operations of a plurality of setting items are continuously performed, the third authentication control is effective in the case where the number of setting items which are objects of user authentication is small in a menu such as a function menu of a job in this embodiment.

Next, in order to perform scanning, the user pushes the OK button 36 in the state where the scan function menu is displayed. The scan starting operation is a job starting operation which is an object of user authentication like the print starting operation described in the first embodiment, so that the control unit 12 displays the user authentication screen. When the user is successful in authentication by inputting suitable passwords and pushing the OK button 36, the control unit 12 starts to execute the scan.

### First Modified Example of Second Embodiment

In the second embodiment described above, when the reference operation and the change operation of the “storage” that are the second reference/change operations which are objects of user authentication are continuously performed, user authentication is required for both the reference and the change operations.

However, when the operation immediately before the change operation of the setting item which is the second reference/change operation which is an object of user authentication is a reference operation, which is an object of user authentication, relating to the same setting item performed within a predetermined interval, and the user authentication is successful, it is preferable that user authentication not be required during subsequent change operations. That is, when the user authentication for the reference operation relating to the same “storage” is successful and the change operation of the “storage” is subsequently performed within the predetermined interval, the control unit 12 does not display the user authentication screen during the change operation.

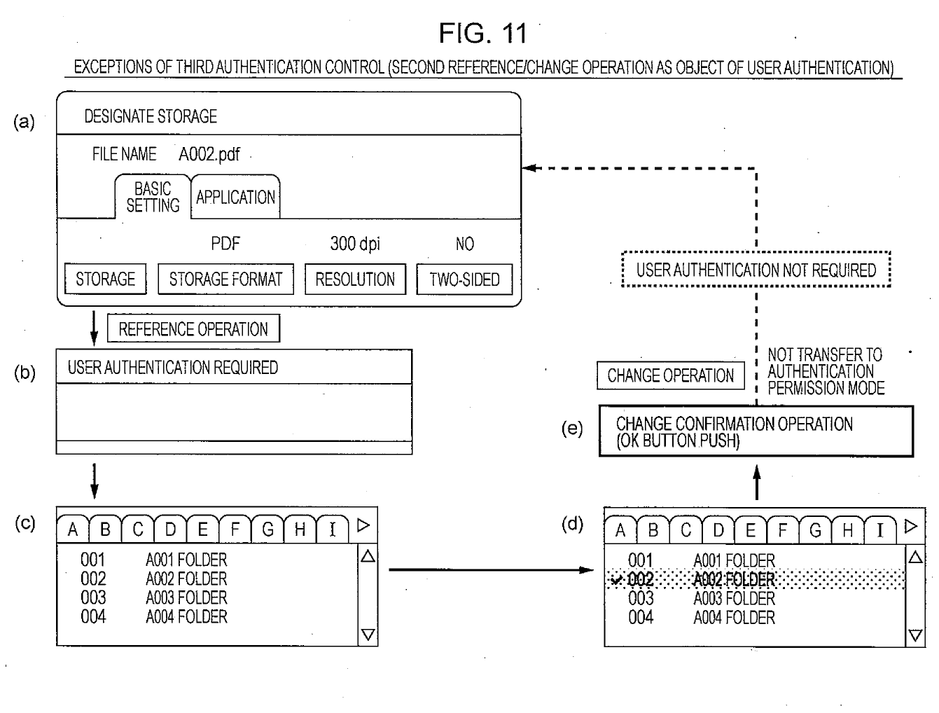

FIGS. 11A to 11E are diagrams of a panel transition shown when a series of second reference/change operations which are objects of user authentication is performed. A process of referring to the “storage” screen by the user on the scan function menu (FIG. 11A) is the same as that of the embodiment described with reference to FIGS. 10A to 10F. In addition, when the user selects the “002 A002 folder” (FIG. 11D) on the “storage” screen (FIG. 11C) and pushes the OK button 36 (FIG. 11E) within the predetermined time after the use authentication has succeeded after the reference operation, since the preceding operation is a reference operation relating to the same setting item and the user authentication is successful, the control unit 12 performs the setting operation of the “002 A002 folder” without displaying the user authentication screen exceptionally. However, in the reference/change operation after the setting operation, user authentication is required anew.

Accordingly, when the reference and the change operations of the setting item which is the object of user authentication are continuously performed, the user may perform user authentication for the reference operation and does not need to perform the user authentication for the change operation. Therefore, it is possible to enhance convenience for the user.

As described above, in this embodiment, user authentication is not required at the time of starting an operation of the operation panel 11, but user authentication is required only for operations which are objects of user authentication. In addition, in the first authentication control for a job starting operation which is an object of user authentication, the user authentication is required only for a job starting operation without transferring to the authentication permission mode. Therefore, a logout operation is not necessary after starting the job.

In addition, in the second authentication control for the first reference/change operation which is an object of user authentication, after authentication success, transfer is made to the authentication permission mode, and the authentication permission mode is automatically terminated in response to the authentication permission mode termination operation. Accordingly, even in the second authentication control, an additional logout operation is not necessary. In addition, it is possible to solve the complexity of user authentication that may result when reference/change operations of setting items of a plurality of objects of user authentication are continuously performed.

In addition, in the third authentication control for the second reference/change operation which is an object of user authentication, after authentication success, no transfer is made to the authentication permission mode. Accordingly, even in the third authentication control, a logout operation is not necessary. In addition, when the second reference and change operations which are objects of user authentication relating to the same setting item are continuously performed, user authentication during the change operation may be omitted as an exception. In this case, it is possible to solve the complexity of user authentication.

As described above, in this embodiment, the range of user authentication is narrowed to operations which are objects of user authentication, and a logout operation is not necessary after authentication success for an operation which is an object of user authentication, thereby solving the complexity of user authentication. Accordingly, a logout operation can be prevented from being forgotten without inconveniencing the user.

The entire disclosure of Japanese Patent Application No. 2009-036336, filed Feb. 19, 2009 is expressly incorporated by reference herein.

What is claimed is:

1. An image processing apparatus for performing a predetermined job and making a reference to or a change in setting items of the predetermined job and the image processing apparatus, the image processing apparatus comprising:
an operation panel that receives a job starting operation for instructing execution of the job and a reference/change operation for making a reference to or a change in the setting items; and
a panel controller that controls the operation panel,
wherein the panel controller detects whether a user operation received by the operation panel is the job starting operation or the reference/change operation and determines whether or not the user operation is an operation which is an object of user authentication, and
the panel controller performs first authentication control of, when the job starting operation that is the operation which is an object of user authentication is received, requiring the user authentication and permitting starting of the job after authentication success without transferring to an authentication permission mode, and performs second authentication control of, when a first reference/change operation that is the operation which is an object of user authentication is received when not in the authentication permission mode, requiring the user authentication, permitting the first reference/change operation after authentication success, and transferring to the authentication permission mode, and in the authentication permission mode, permitting the first reference/change operation without requiring the user authentication and terminating the authentication permission mode in response to an authentication permission mode termination operation.

2. The image processing apparatus according to claim 1,
wherein the first reference/change operation is an operation in a setting menu having a setting screen with a plurality of the setting items, and
the authentication permission mode termination operation is a termination operation of the setting menu.

3. The image processing apparatus according to claim 2, wherein the panel controller performs third authentication control of, when the user operation is a second reference/change operation which is an object of user authentication, requiring the user authentication, and permitting the second reference/change operation after authentication success without transferring to the authentication permission mode.

4. The image processing apparatus according to claim 3, wherein in the third authentication control, when the user operation is the second reference/change operation which is the object of user authentication and is the change operation relating to the same setting item continuously performed for a predetermined period after the user authentication for the reference operation that is the second reference/change operation which is the object of user authentication has succeeded, the change operation is permitted without requiring the user authentication.

5. The image processing apparatus according to claim 1, wherein the job starting operation or the first or second reference/change operation which are the objects of user authentication may be selected by a manager.

6. The image processing apparatus according to claim 1, wherein, in the second authentication control, the authentication permission mode is terminated when the operation panel is not operated for a predetermined period during the authentication permission mode.

7. The image processing apparatus according to claim 1,
wherein the image processing apparatus includes at least an image reading unit and an image printing unit, and
the predetermined job includes an image reading process and an image data printing process.

8. The image processing apparatus according to claim 1,
wherein the image processing apparatus includes at least an image reading unit and an image printing unit, and
the setting items include communication related items of the image processing apparatus.

9. A control method of an image processing apparatus for performing a predetermined job and making a reference to or change in setting items of the predetermined job and the image processing apparatus, the control method comprising:
a panel control process of receiving a job starting operation for instructing execution of the job and a reference/change operation for making a reference to or change in the setting items by an operation panel,
wherein the panel control process includes:
an operation determination process of detecting whether a user operation received by the operation panel is the job starting operation or the reference/change operation and determining whether or not the user operation is an operation which is an object of user authentication;
a first authentication control process of, when the job starting operation that is the operation which is an object of user authentication is received as the user operation, requiring the user authentication, and permitting starting of the job after authentication success, without transferring to an authentication permission mode; and
a second authentication control process of, when a first reference/change operation that is the operation which is an object of user authentication is received as the user operation when not in the authentication permission mode, requiring the user authentication, permitting the first reference/change operation after authentication success, and transferring to the authentication permission mode, and in the authentication permission mode, permitting the first reference/change operation without requiring the user authentication, and terminating the authentication permission mode in response to an authentication permission mode termination operation.
